(19) United States
(12) Patent Application Publication
(10) Pub. No.: US 2012/0248024 A1
(43) Pub. Date: Oct. 4, 2012

(54) Filter with Inner-Sealed Pulsation Dampener

(75) Inventors: Aaron M. Wells, Cookeville, TN (US); Charles W. Hawkins, Sparta, TN (US); Scott A. Salsburey, Ottawa, OH (US)

(73) Assignee: KUSS FILTRATION, INC., Findlay, OH (US)

(21) Appl. No.: 13/348,822

(22) Filed: Jan. 12, 2012

Related U.S. Application Data
(60) Provisional application No. 61/468,629, filed on Mar. 29, 2011.

(51) Int. Cl. B01D 29/13; B01D 35/30; B01D 27/08; B01D 35/00

(52) U.S. Cl. 210/238; 210/349; 210/232

(57) ABSTRACT

A filter and replacement filter cartridge is provided with a pulsation dampener mounted and sealed to the filter cartridge basket at an inner diameter thereof. The pulsation dampener is captive to the basket such that removal of the basket from the filter housing canister removes all of the basket, filter media, and pulsation dampener as a single unit without separate, loose parts thereof. An axial extension section of the basket facilitates gripping and removal, and maintains a fully seated installed filter position. Sealing is provided without a section of the pulsation dampener interposed between the filter housing canister and lid.

### CROSS-REFERENCE TO RELATED APPLICATION(S)

This application claims the benefit of and priority from Provisional U.S. Patent Application No. 61/468,629, filed Mar. 29, 2011, incorporated herein by reference.

### BACKGROUND AND SUMMARY

The invention relates to filters with pulsation dampeners, and more particularly to a replaceable filter cartridge with an inner-sealed pulsation dampener.

Filters with pulsation dampeners are known. An elastomeric dampener acts as a volumetric spring to compress during flow/pressure surges to increase system volume and reduce pressure spikes, and also to act as an accumulator, e.g. during the suction stroke of positive displacement pumps in such application.

The present disclosure arose during continuing development efforts in the above technology.

### BRIEF DESCRIPTION OF THE DRAWINGS

FIG. 1 is sectional view of a filter known in the prior art.

FIG. 2 is a sectional view of a filter and replaceable filter cartridge in accordance with the present disclosure.

FIG. 3 is a perspective view partly in section of a portion of FIG. 2.

FIG. 4 is a perspective view of a portion of FIG. 2 and showing a further embodiment.

FIG. 5 is like FIG. 4 but from a different perspective angle.

FIG. 6 is a perspective view of a portion of FIG. 4.

FIG. 7 is a perspective view of another portion of FIG. 4.

### DETAILED DISCLOSURE

### Prior Art

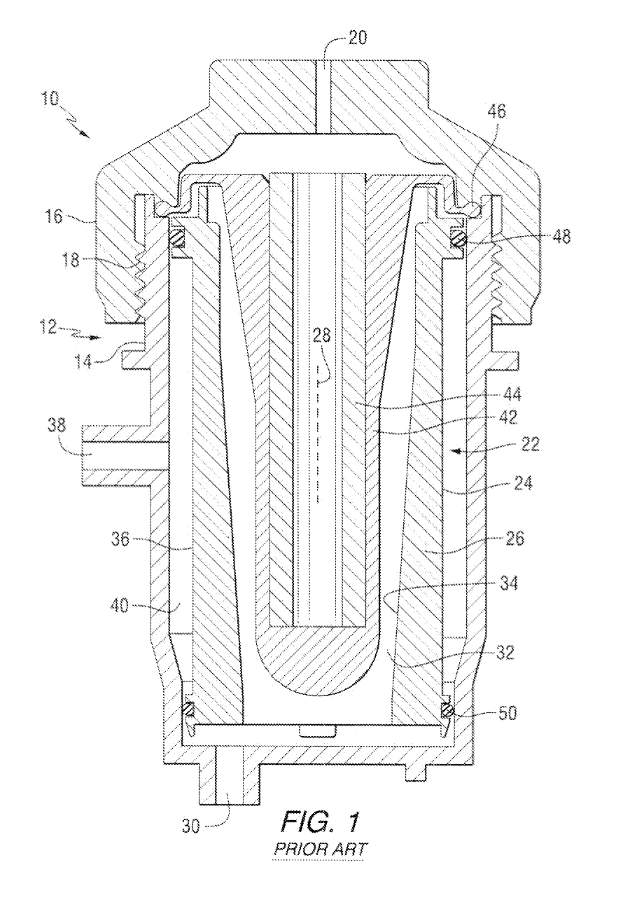

FIG. 1 shows a filter 10 known in the prior art including a housing 12 having a canister 14 closed by a removable lid 16, e.g. in threaded relation at 18. The lid has a vent hole bore 20 to allow venting of air as the dampener expands and contracts, to be described. A replaceable filter cartridge 22 in the housing includes filter media 24 supported by a basket 26. The filter cartridge extends axially along axis 28 in the housing. The filter is an inside-out flow filter wherein fluid to be filtered flows through inlet 30 into the filter interior 32 defined by the inner diameter 34 of the filter and then flows radially outwardly through the filter media to the outer diameter 36 of the filter and then through outlet 38. Inner diameter 34 of the filter media element defines a dirty-fluid inner volume 32. Outer diameter 36 of the filter media element defines a clean-fluid outer volume 40. Pulsation dampener 42 is an elastomeric member, which may include one or more additional elastomeric sleeves or liners such as 44, which may have a different modulus of elasticity. As is known, the dampener acts as a volumetric spring to compress during flow/pressure surges to increase system volume and reduce pressure spikes, and also to act as an accumulator, e.g. during the suction stroke of a positive displacement pump in such application. The pulsation dampener has an upper lip 46 axially sealed between canister 14 and lid 16 upon threaded engagement and assembly of the lid to the canister. The filter cartridge is sealed in canister 14 at upper and lower O-rings 48 and 50.

### Present Disclosure

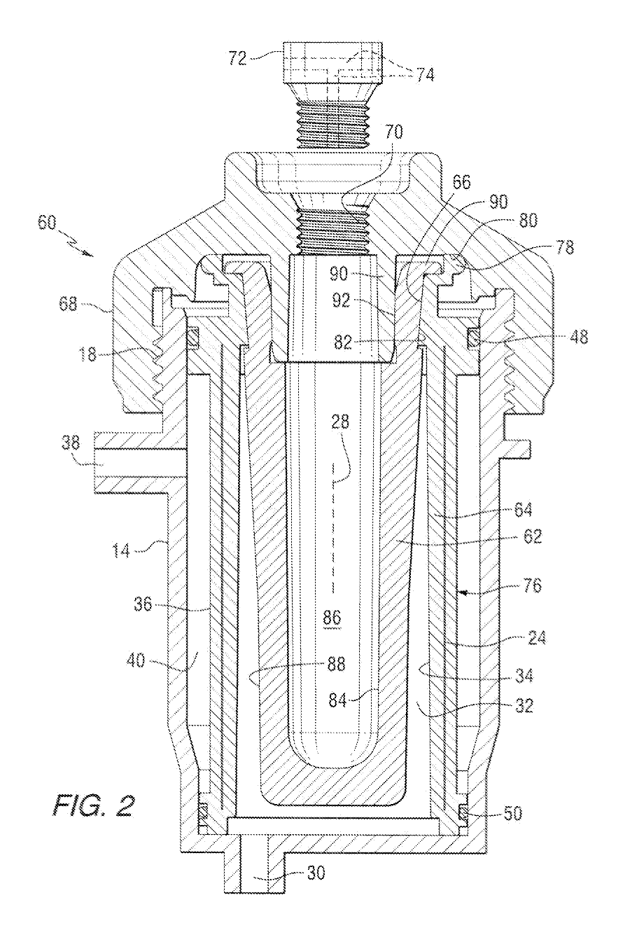

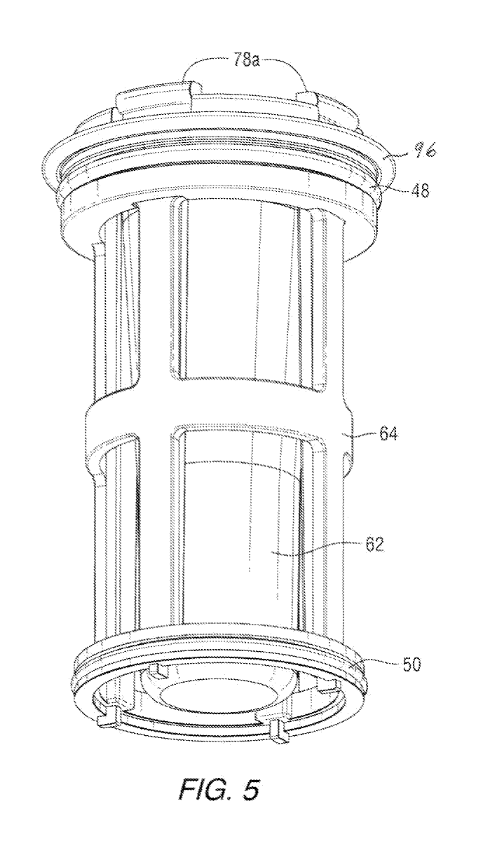

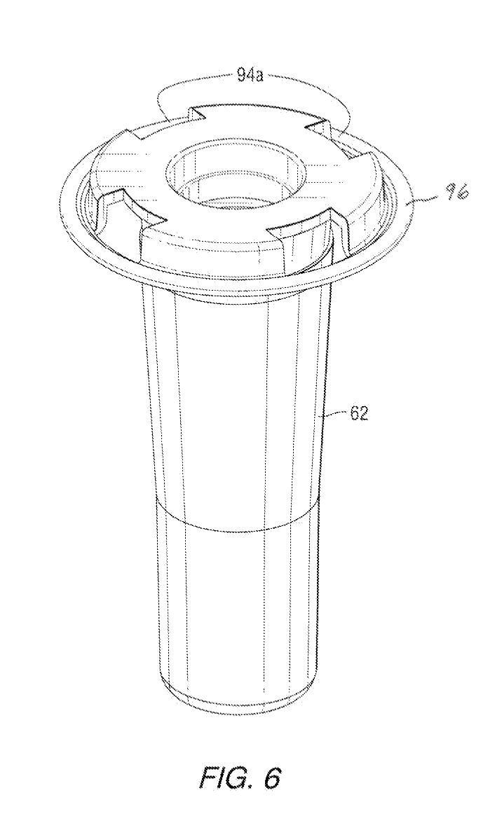

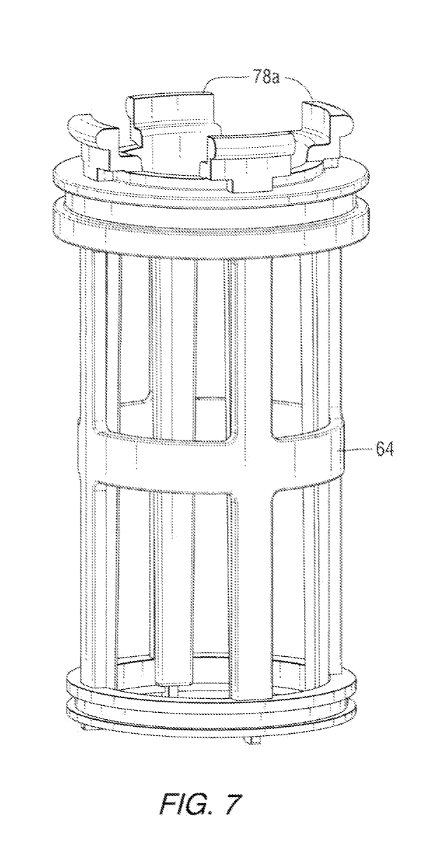

FIGS. 2-7 show a filter 60 in accordance with the present disclosure and use like reference numerals from above where appropriate to facilitate understanding.

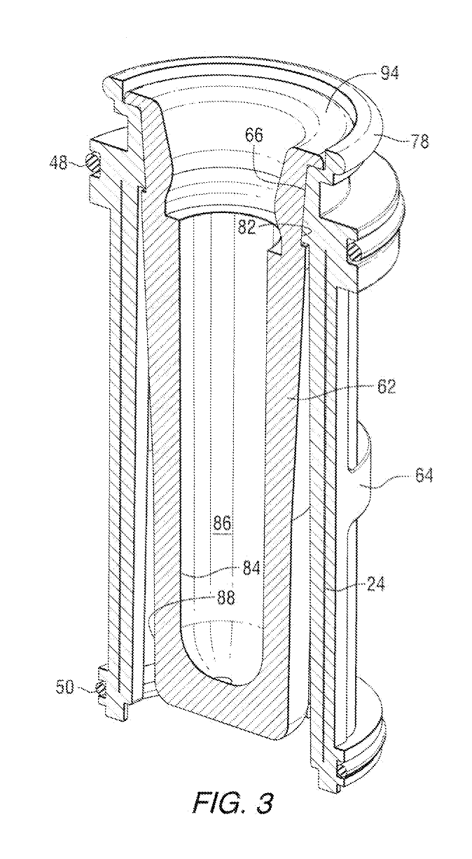

In FIG. 2, pulsation dampener 62 in inner volume 32 is mounted and sealed to filter cartridge basket 64 at the inner diameter of the latter as shown at 66. This is in contrast to the mounting and sealing of the pulsation dampener in FIG. 1 at 46. In FIG. 2, pulsation dampener 62 is captive to basket 64 such that removal of basket 64 from canister 14 removes all of basket 64, O-rings 48, 50, filter media 24, and pulsation dampener 62 as a single unit without separate, loose parts thereof. This can be further seen in viewing FIGS. 3-7. Lid 68 in FIG. 2 replaces lid 16 of FIG. 1 and has a threaded bore at 70 receiving a venting component 72 provided by a threaded nut threaded into threaded bore 70 and having a vent hole bore 74 allowing venting of air as the dampener expands and contracts, as above.

Basket 64 of filter cartridge 76 includes an axial extension section 78 extending axially away from the filter media and toward lid 68 and engaged by lid 68 at the latter's undersurface 80 to retain filter cartridge 76 in properly seated position in canister 14 upon closing by lid 68. Axial extension section 78 of basket 64 is directly engaged in touching contact at 80 with lid 68 without pulsation dampener 62 interposed therebetween. This is in contrast to FIG. 1 wherein the pulsation dampener at 46 is interposed between lid 16 and canister 14. In FIGS. 2, 3, axial extension section 78 of the filter cartridge basket extends axially beyond pulsation dampener 62. Pulsation dampener 62 has an undercut section 82 interfacing with basket 64 and held captive thereto at the undercut section. Axial extension section 78 of the basket extends axially beyond undercut section 82. Axial extension section 78 extends axially beyond canister 14 and is grippable by a user to provide a removal aid to facilitate easy removal of filter cartridge 76, in contrast to FIG. 1.

Pulsation dampener 62, FIGS. 2, 3, has an inner diameter 84 defining a hollow inner volume 86. Pulsation dampener 62 has an outer diameter 88 radially facing inner diameter 34 of filter cartridge 76. Lid 68 has a central axially extending tube 90 extending axially into hollow inner volume 86 of the pulsation dampener and engaging the inner diameter of the pulsation dampener at 92 and forming an inner sealing section thereat, which provides a radial seal. Outer diameter 88 of pulsation dampener 62 has an outer sealing section at undercut section 82 engaging filter cartridge 76 in sealing relation thereat, providing a radial seal. The outer sealing section at 82 is radially aligned with and radially distally opposite the inner sealing section at 92.

The disclosure provides a replacement filter cartridge 76 for a filter 60 having a housing provided by a canister 14 closed by a removable lid 68. The replacement filter cartridge has a pulsation dampener 62 mounted and sealed to the filter cartridge basket 64 at the inner diameter thereof.

In the prior art, during filter service change, the filter/dampener assembly can be difficult to remove from the housing since there are no features to afford adequate grip on the filter cartridge. Consequently, the end user must remove the elastomeric dampener and use pliers or other tools to grab any accessible portion of the filter basket to be able to remove it. Furthermore, the prior art does not prevent the filter from moving axially upwards into the housing cap or lid during operation and losing integrity of the seal of the upper O-ring, allowing a dirty to clean side bypass. In addition, the prior art does not prevent the user from not completely seating the filter element in the housing and creating a dirty to clean fluid bypass around the top O-ring. The present disclosure provides desirable sealing, and provides easy removal of the filter cartridge, and ensures that the filter cartridge is fully seated during installation and during operation to prevent dirty to clean fluid bypass. In the present disclosure, the dampener is sealed to the ID of the filter cartridge basket and held captive thereto by the noted grommet type undercut 82. This avoids the end user having to handle an assembly with loose parts. Upon insertion during assembly, the two OD radially sealing O-rings 48, 50 create axial resistance for resisting insertion. If the user does not fully seat the filter cartridge manually, the removal feature protrusion at axial extension section 78 of the basket will make contact with the inside surface or undersurface 80 of lid 68 which will force the filter cartridge 76 into position. Dampener 62 also creates a seal between the unfiltered fluid and atmosphere by sealing radially between filter cartridge basket 64 and axial protrusion tube 90 of housing lid 68. This sealing construction facilitates the noted filter removal aid feature. By moving the seal to the ID of the filter cartridge, the filter basket can be extended axially at 78 to create a grab handle for the user to grasp during filter service removal without the use of additional tools. This also provides the noted touch point at 80 on the undersurface of lid 16 to maintain a fully seated installed filter position upon completion of servicing.

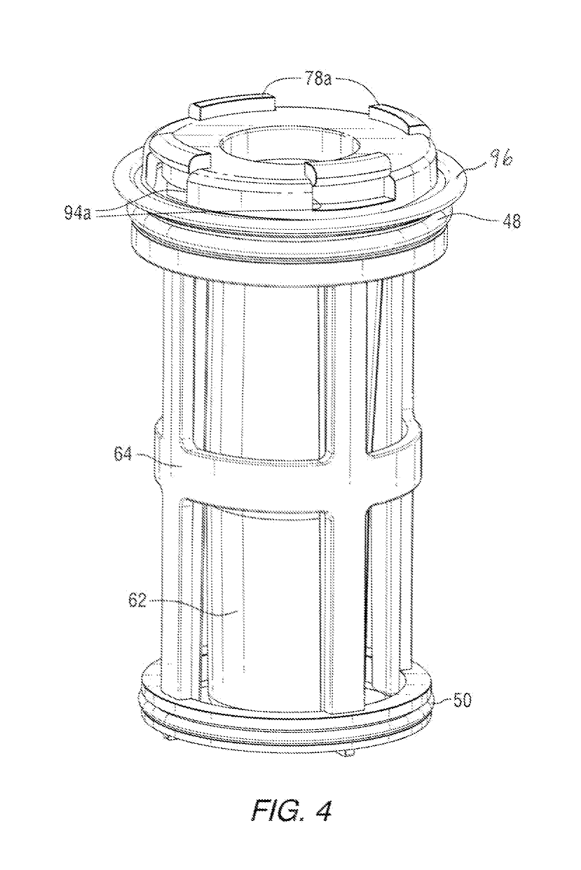

In one embodiment, FIG. 3, the upper axial extension section 78 of filter cartridge basket 64 is a continuous annulus, as is upper flange 94 of pulsation dampener 62. In another embodiment, FIGS. 4-7, section 78 may instead be provided by a plurality of circumferentially spaced fingers such as 78a, and flange 94 may have a plurality of circumferentially spaced cut-outs or slots as shown at 94a, receiving respective fingers 78a. In a further embodiment, pulsation dampener 62 may have an outer circumferential lip 96, FIGS. 4-6, engaged in sealing relation between lid 16 and canister 14, comparably to lip 46 in FIG. 1, to provide further sealing in addition to the sealing 49 provided by upper O-ring 48, if desired.

The disclosure may be used in an inside-out flow implementation, as noted. In an alternate embodiment, the disclosure may be used in an outside-in flow implementation. In this embodiment, port 38 provides the inlet, and port 30 provides the outlet, and fluid to be filtered flows from outer diameter 36 of the filter radially inwardly through filter media 24 to inner diameter 34, with the outer diameter defining a dirty-fluid outer volume, and the inner diameter defining a clean-fluid inner volume.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C.§112, sixth paragraph, only if the terms “means for” or “step for” are explicitly recited in the respective limitation.

What is claimed is:

1. A filter comprising a housing comprising a canister closed by a removable lid, a replaceable filter cartridge in said housing, said filter cartridge comprising filter media supported by a basket, said filter cartridge extending axially in said housing and having an outer diameter and an inner diameter, wherein fluid to be filtered flows radially through said filter media between said inner and outer diameters, said inner diameter defining an inner volume, said outer diameter defining an outer volume, a pulsation dampener in said inner volume and mounted and sealed to said basket at said inner diameter.

2. The filter according to claim 1 wherein said pulsation dampener is captive to said basket such that removal of said basket from said canister removes all of said basket, said filter media, and said pulsation dampener as a single unit without separate, loose parts thereof.

3. The filter according to claim 1 wherein said basket comprises an axial extension section extending axially away from said filter media and toward said lid and engaged by said lid to retain said filter cartridge in properly seated position in said canister upon closing by said lid.

4. The filter according to claim 3 wherein said axial extension section of said basket is directly engaged in touching contact with said lid without said pulsation dampener interposed therebetween.

5. The filter according to claim 3 wherein said axial extension section extends axially beyond said pulsation dampener.

6. The filter according to claim 3 wherein said pulsation dampener has an undercut section interfacing with said basket, and wherein said pulsation dampener is mounted and sealed to said basket and held captive thereto at said undercut section.

7. The filter according to claim 6 wherein said axial extension section extends axially beyond said undercut section.

8. The filter according to claim 3 wherein said axial extension section extends axially beyond said canister and is grippable by a user to provide a removal aid to facilitate easy removal of said filter cartridge.

9. The filter according to claim 1 wherein said pulsation dampener has an inner diameter defining a hollow inner volume, said pulsation dampener has an outer diameter radially facing said inner diameter of said filter cartridge, said lid has a central axially extending tube extending axially into said hollow inner volume of said pulsation dampener and engaging said pulsation dampener at said inner diameter of said pulsation dampener and forming an inner sealing section.

10. The filter according to claim 9 wherein said inner sealing section is a radial seal.

11. The filter according to claim 1 wherein said pulsation dampener has an inner diameter defining a hollow inner volume, said pulsation dampener has an outer diameter radially facing said inner diameter of said filter cartridge, wherein said outer diameter of said pulsation dampener has an outer sealing section engaging said filter cartridge in sealing relation.

12. The filter according to claim 11 wherein said outer sealing section is a radial seal.

13. The filter according to claim 1 wherein said pulsation dampener has an inner diameter defining a hollow inner volume, said pulsation dampener has an outer diameter radially facing said inner diameter of said filter cartridge, said lid has a central axially extending tube extending axially into said hollow interior of said pulsation dampener and engaging said pulsation dampener at said inner diameter of said pulsation dampener and forming an inner sealing section, said outer diameter of said pulsation dampener has an outer sealing section engaging said filter cartridge in sealing relation, wherein said outer sealing section is radially aligned with and radially distally opposite said inner sealing section.

14. The filter according to claim 3 wherein said axial extension section is a continuous annulus.

15. The filter according to claim 14 wherein said pulsation dampener has a flange at said axial extension, wherein said flange is a continuous annulus.

16. The filter according to claim 3 wherein said axial extension section comprises a plurality of circumferentially spaced axially extending fingers.

17. The filter according to claim 16 wherein said pulsation dampener has a flange at said axial extension section, wherein said flange has a plurality of circumferentially spaced cut-outs receiving respective said fingers.

18. The filter according to claim 1 wherein said filter is an inside-out flow filter, wherein fluid to be filtered flows from said inner diameter radially outwardly through said filter media to said outer diameter, said inner diameter defining a dirty-fluid inner volume, said outer diameter defining a clean-fluid outer volume.

19. The filter according to claim 1 wherein said filter is an outside-in flow filter, wherein fluid to be filtered flows from said outer diameter radially inwardly through said filter media to said inner diameter, said outer diameter defining a dirty-fluid outer volume, said inner diameter defining a clean-fluid inner volume.

20. The filter according to claim 1 wherein said pulsation dampener has an outer circumferential lip engaged in sealing relation between said lid and said canister.

21. The filter according to claim 20 wherein said pulsation dampener is captive to said basket such that removal of said basket from said canister removes all of said basket, said filter media, and said pulsation dampener as a single unit without separate, loose parts thereof, and wherein said basket comprises an axial extension section extending axially away from said filter media and toward said lid and engaged by said lid to retain said filter cartridge in properly seated position in said canister upon closing by said lid.

22. A replacement filter cartridge for a filter having a housing having a canister closed by a removable lid, said replacement filter cartridge comprising filter media supported by a basket, said filter cartridge extending axially in said housing and having an outer diameter and an inner diameter, wherein fluid to be filtered flows radially through said filter media between said inner and outer diameters, said inner diameter defining an inner volume, said outer diameter defining an outer volume, a pulsation dampener in said inner volume and mounted and sealed to said basket at said inner diameter.

23. The replacement filter cartridge according to claim 22 wherein said pulsation dampener is captive to said basket such that removal of said basket from said canister removes all of said basket, said filter media, and said pulsation dampener as a single unit without separate, loose parts thereof.

24. The replacement filter cartridge according to claim 22 wherein said basket comprises an axial extension section extending axially away from said filter media and toward said lid and engaged by said lid to retain said filter cartridge in properly seated position in said canister upon closing by said lid.

25. The replacement filter cartridge according to claim 24 wherein said axial extension section of said basket is directly engaged in touching contact with said lid without said pulsation dampener interposed therebetween.

26. The replacement filter cartridge according to claim 24 wherein said axial extension section extends axially beyond said pulsation dampener.

27. The replacement filter cartridge according to claim 24 wherein said pulsation dampener has an undercut section interfacing with said basket, and wherein said pulsation dampener is mounted and sealed to said basket and held captive thereto at said undercut section.

28. The replacement filter cartridge according to claim 27 wherein said axial extension section extends axially beyond said undercut section.

29. The replacement filter cartridge according to claim 24 wherein said axial extension section extends axially beyond said canister and is grippable by a user to provide a removal aid to facilitate easy removal of said filter cartridge.

30. The replacement filter cartridge according to claim 22 wherein said pulsation dampener has an inner diameter defining a hollow inner volume, said pulsation dampener has an outer diameter radially facing said inner diameter of said filter cartridge, said lid has a central axially extending tube extending axially into said hollow inner volume of said pulsation dampener and engaging said pulsation dampener at said inner diameter of said pulsation dampener and forming an inner sealing section.

31. The replacement filter cartridge according to claim 30 wherein said inner sealing section is a radial seal.

32. The replacement filter cartridge according to claim 22 wherein said pulsation dampener has an inner diameter defining a hollow inner volume, said pulsation dampener has an outer diameter radially facing said inner diameter of said filter cartridge, wherein said outer diameter of said pulsation dampener has an outer sealing section engaging said filter cartridge in sealing relation.

33. The replacement filter cartridge according to claim 32 wherein said outer sealing section is a radial seal.

34. The replacement filter cartridge according to claim 22 wherein said pulsation dampener has an inner diameter defining a hollow inner volume, said pulsation dampener has an outer diameter radially facing said inner diameter of said filter cartridge, said lid has a central axially extending tube extending axially into said hollow interior of said pulsation dampener and engaging said pulsation dampener at said inner diameter of said pulsation dampener and forming an inner sealing section, said outer diameter of said pulsation dampener has an outer sealing section engaging said filter cartridge in sealing relation, wherein said outer sealing section is radially aligned with and radially distally opposite said inner sealing section.

35. The replacement filter cartridge according to claim 24 wherein said axial extension section is a continuous annulus.

36. The replacement filter cartridge according to claim 35 wherein said pulsation dampener has a flange at said axial extension, wherein said flange is a continuous annulus.

37. The replacement filter cartridge accordingly to claim 24 wherein said axial extension section comprises a plurality of circumferentially spaced axially extending fingers.

38. The replacement filter cartridge according to claim 37 wherein said pulsation dampener has a flange at said axial extension section, wherein said flange has a plurality of circumferentially spaced cut-outs receiving respective said fingers.

39. The replacement filter cartridge according to claim 22 wherein said filter is an inside-out flow filter, wherein fluid to be filtered flows from said inner diameter radially outwardly through said filter media to said outer diameter, said inner diameter defining a dirty-fluid inner volume, said outer diameter defining a clean-fluid outer volume.

40. The replacement filter cartridge according to claim 22 wherein said filter is an outside-in flow filter, wherein fluid to be filtered flows from said outer diameter radially inwardly through said filter media to said inner diameter, said outer diameter defining a dirty-fluid outer volume, said inner diameter defining a clean-fluid inner volume.

41. The replacement filter cartridge according to claim 22 wherein said pulsation dampener has an outer circumferential lip engaged in sealing relation between said lid and said canister.

42. The replacement filter cartridge according to claim 41 wherein said pulsation dampener is captive to said basket such that removal of said basket from said canister removes all of said basket, said filter media, and said pulsation dampener as a single unit without separate, loose parts thereof, and wherein said basket comprises an axial extension section extending axially away from said filter media and toward said lid and engaged by said lid to retain said filter cartridge in properly seated position in said canister upon closing by said lid.
